(19) United States
(12) Patent Application Publication
(10) Pub. No.: US 2019/0006902 A1
(43) Pub. Date: Jan. 3, 2019

(54) COIL ARRANGEMENT AND HOUSING MODULE SET FOR A COIL ARRANGEMENT OF AN ELECTRIC MOTOR

(71) Applicant: ETEL S.A., Motiers (CH)

(72) Inventors: Jose Manuel Fernandes Goncalves, Colombier (CH); Alfred Gause, Baltmannsweiler (DE); Sylwia Szczukiewicz, Colombier (CH); Nicola Bosco, Neuchatel (CH); Boris Herrmann, Montperreux (FR)

(21) Appl. No.: 16/001,992

(22) Filed: Jun. 7, 2018

(30) Foreign Application Priority Data
Jun. 30, 2017 (EP) 17 178 938.1

(51) Int. Cl. H02K 3/47; H02K 41/03; H02K 15/06

(52) U.S. Cl. CPC H02K 3/47; H02K 15/061; H02K 41/03

(57) ABSTRACT

A coil arrangement for an electric motor includes a plurality of individual coils and a plurality of housing modules. Each of the housing modules is a plastics part that is separately produced from the coil arrangement. Each of the housing modules is designed to enclose the same amount of the individual coils.

### CROSS-REFERENCE TO PRIOR APPLICATION

Priority is claimed to European Patent Application No. EP 17 178 938.1, filed on Jun. 30, 2017, the entire disclosure of which is hereby incorporated by reference herein.

### FIELD

The present invention relates to a coil arrangement for an electric motor comprising a number of individual coils and a number of housing modules. The present invention also relates to a housing module set for a coil arrangement for an electric motor, wherein the housing module set is in particular a modular housing module set for a coil arrangement of an electric motor in the form of an ironless linear motor.

### BACKGROUND

Examples of ironless linear motors (this referring in particular to coreless linear motors) are known from DE 10 2015 222 265 A1 and EP 2 884 638 A1.

Linear motors are used, for example, if objects, such as a machine component of a tool machine, are to be positioned in a highly precise manner and possibly also quickly. In this case, the primary part of the linear motor may be directly connected to the machine component to be moved or other object by means of a suitable interface. This means that, in contrast with a conventional rotary motor, in this case there is usually no need for a transmission connected between the linear motor and the object to be driven.

“Ironless linear motors” in which at least one coil provided in the primary part is not associated with a core, such as an iron core, are particularly suitable for applications requiring particularly precise positioning. This makes it possible to avoid disruptive latching forces. However, accordingly larger coil currents are required to also generate sufficiently large forces in the primary part of the linear motor without a core. This in turn requires an accordingly effective cooling system for the coil(s) (also referred to generally as a coil arrangement below).

Coil arrangements of this kind are provided, for example, in the form of pre-formed individual coils. This means that the wire that is used to form the coil arrangement and is provided, for example, with an insulation layer is not directly wound on a core, but is wound without a core, for example, and then installed to form the electric motor. In this process, the coreless individual coil may be placed onto an iron core integrated in the electric motor; however, the individual coil may also be operated as an “air-core coil” in the electric motor without an associated core.

In particular if an electric motor, for example in the form of a linear motor, is intended to be used to position objects, such as a machine part of a tool machine, in a highly precise manner and possibly also quickly, a low weight of the used coil arrangement is advantageous. The absence of an iron core may make a significant contribution to this. However, as mentioned, accordingly larger coil currents are in this case required to also generate sufficiently large forces in the motor without an iron core. This in turn requires a particularly effective cooling system for the coil arrangement. In this regard, EP 2 808 986 A1 describes a plurality of individual coils that are arranged on an extensive cooling body for cooling.

As used herein, an individual coil is understood to mean at least one coil wound from wire provided with an insulation layer.

The electric motor may also be designed as a motor that has multiple phases and a plurality of individual coils, it being possible for the plurality to correspond to a whole-number multiple of the phases. For example, an electric motor having three phases may, for example, have 3, 6, 9 or 12, i.e. N*3, individual coils. The number of individual coils provided may depend on the performance class of the electric motor.

### SUMMARY

In an embodiment, the present invention provides a coil arrangement for an electric motor. The coil arrangement includes a plurality of individual coils and a plurality of housing modules. Each of the housing modules is a plastics part that is separately produced from the coil arrangement. Each of the housing modules is designed to enclose the same amount of the individual coils.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic view, given by way of example, of a detail of a coil arrangement having three individual coils that are enclosed in a housing module, according to one or more embodiments;

FIG. 2 is a schematic view, given by way of example, of a detail of a housing module set having three housing modules for a coil arrangement according to one or more embodiments;

FIG. 3 is a schematic view, given by way of example, of a detail of a lower part of a housing module according to one or more embodiments;

FIG. 4 is a schematic view, given by way of example, of a detail of a lower part of a housing module according to one or more embodiments;

FIG. 5 is a schematic view, given by way of example, of a detail of a lower part and an upper part of a housing module according to one or more embodiments;

FIG. 6 is a schematic view, given by way of example, of a detail of a housing module according to one or more embodiments;

FIG. 7 is a schematic view, given by way of example, of a side wall structure of a housing module according to one or more embodiments;

FIG. 8 is a schematic view, given by way of example, of a detail of two housing modules to be coupled to one another according to one or more embodiments;

FIG. 9 is a schematic view, given by way of example, of a detail of a housing module according to one or more embodiments;

FIG. 10 is a schematic view, given by way of example, of a detail of a housing module according to one or more embodiments;

FIG. 11 is a schematic view, given by way of example, of a detail of a cross-sectional view of a housing module according to one or more embodiments;

FIG. 12 is a schematic view, given by way of example, of a detail of a lower part and an upper part of a housing module according to one or more embodiments;

FIG. 13 is a schematic view, given by way of example, of the process of joining a lower part and an upper part of a housing module according to one or more embodiments;

FIG. 14 is a schematic view, given by way of example, of a detail of a housing module and possible coupling points for holding together the upper part and the lower part of the housing module according to one or more embodiments;

FIG. 15 is a schematic view, given by way of example, of a detail of multi-reinforcement elements of a housing module according to one or more embodiments;

FIG. 16 is a schematic view, given by way of example, of a detail of multi-reinforcement elements of a housing module according to one or more embodiments;

FIG. 17 is a schematic view, given by way of example, of a detail of a housing module according to one or more embodiments;

FIG. 18 is a schematic view, given by way of example, of the process of joining a lower part and an upper part of a housing module according to one or more embodiments; and

FIG. 19 is a schematic view, given by way of example, of the process of joining a lower part and an upper part of a housing module according to one or more embodiments.

### DETAILED DESCRIPTION

Embodiments of the invention provide possibilities for allowing various performance classes of an electric motor to be produced in a cost-effective manner.

According to an embodiment, a coil arrangement for an electric motor comprises a number of individual coils and a number of housing modules, each of which modules is designed to enclose the same amount of the number of individual coils, each of the housing modules having been produced separately from the coil arrangement as a plastics part.

According to another embodiment, a housing module set for a coil arrangement comprises a number of housing modules, each of which is designed to enclose the same amount of the number of individual coils of the coil arrangement, each of the housing modules having been produced separately from the coil arrangement as a plastics part.

The electric motor is, for example, a linear motor, e.g. an ironless linear motor. With regard to its electromechanical function, the electric motor may be formed as is described, for example, in DE 10 2015 222 265 A1 and EP 2 884 638 A1.

The coil arrangement having the number of individual coils may form a primary part, e.g. the stator, of the electric motor. The individual coils may each be ironless individual coils, i.e. formed as air-core coils, for example. For example, each individual coil comprises a coil that has been wound from a wire provided with an insulation layer.

According to one embodiment, the electric motor is designed as a multi-phase electric motor, for example as an ironless linear motor having three phases. For example, the coil arrangement has at least one individual coil for each of the phases of the electric motor. The electric motor may also be provided in various classes. For example, just a single individual coil is provided for each phase for a class 1 electric motor, two individual coils are provided for each phase for a class 2 electric motor, three individual coils are provided for each phase for a class 3 electric motor, four individual coils are provided for each phase for a class 4 electric motor, and so on.

For example, each housing module is designed to enclose a number of individual coils that corresponds to the number of phases of the electric motor. Therefore, if said motor is a three-phase electric motor, for example, each housing module is designed so as to enclose three individual coils.

In one embodiment, the electric motor may be a multi-phase electric motor, and the number of individual coils corresponds to the number of phases multiplied by a whole-number factor, the number of housing modules being identical to the whole-number factor. For example, only one housing module is provided for an above-described class 1 electric motor, two housing modules are provided for a class 2 electric motor, three housing modules are provided for a class 3 electric motor, four housing modules are provided for a class 4 electric motor, and so on. The factor can thus express a performance class of the electric motor.

The housing modules may each be designed to completely enclose a number of at least two individual coils and insulate said coils from the surroundings. The housing modules may also each be designed to be filled with an insulating filler, for example a potting material, such as a resin.

For example, the housing modules are each produced as a plastics part, for example as an injection-molded part, in a manner separate from the production of the coil arrangement. The formation of the coil arrangement may therefore include integrating the individual coils in the housing modules.

A plurality of housing modules may form the housing module set. For example, all the housing modules have a sufficient number of identical dimensions such that said modules can be produced by means of an injection-molding process in the same cavity. This may make it more cost-effective to produce the housing module set.

The housing module set may have a modular structure, and for this purpose, it may be expedient for all the housing modules to have identical dimensions. On account of the modular character of the housing module set, electric motors of various performance classes may be formed using housing modules of the same kind and thus in a comparably cost-effective manner.

All the housing modules may also each have at least one coupling element that is designed to couple two housing modules to one another. For example, said coupling elements may each form a latching fastener at least in part. For example, two or more housing modules may be “stuck” to one another on account of the coupling elements so as to form an electric motor of a particular performance class.

In this case, it may be expedient for the at least one coupling element to comprise a recess that is designed to make it possible for an insulating filler to flow between the interiors of the two housing modules that are coupled to one another by means of the at least one coupling element. The coil arrangement for an electric motor of a particular performance class may therefore be formed as follows: first of all, the individual coils and the housing modules are produced separately from one another. The individual coils are then integrated into the housing modules, and the housing modules can be subsequently closed and interconnected by means of said coupling elements. The housing modules can then be filled with the insulating filler (e.g. a potting material, such as a resin), it only being necessary to start with one of the housing modules, for example, as the coupling elements allow flow from one housing module to the other housing module. Since the filler is present and hardens in the recesses in the coupling elements too, this may contribute to a significant increase in stability of the housing module set.

Each housing module may have a lower part and an upper part, which cover the particular enclosed amount of the number of individual coils. The lower part forms, for example, a lower face of the housing module in question, and the upper part forms an upper face. At least one of the lower part and the upper part may have a side wall that is, for example, significantly smaller than the lower face or the upper face in terms of area. The housing module may, for example, be in the shape of a square. For example, both the lower part and the upper part may have outer wall structures which are matched to another, such that a side wall having a double-wall structure is formed when the upper part and the lower part are joined to one another, which may increase the robustness of the housing module.

In another embodiment, the lower part and the upper part are produced as an integral plastics part and are interconnected by means of a flexible side wall. After the housing module has been produced, the lower part and the upper part may be planar with respect to one another, and the flexible side wall may allow the housing module to “fold shut” after the individual coils have been positioned in the lower part or the upper part.

In one embodiment, the lower part and the upper part are of the same kind, for example identical to one another. This allows the housing modules for the various performance classes of the electric motor to be produced in an even more cost-effective manner. For example, the lower part and the upper part may be positioned symmetrically in relation to a longitudinal axis and then joined to one another after the individual coils have been inserted.

According to another embodiment, at least one of the lower part and the upper part comprises a positioning means that allows the individual coils in question to be inserted in a positionally precise manner. For example, each individual coil has an inner hollow (for example, where a core is found in non-ironless coils), and the positioning means is suited, with respect to the dimensions thereof, to said inner hollow in the individual coil. The individual coils can then be “placed over” the positioning means and surround said means following arrangement within the housing module.

Within the scope of the present invention, the lower part and the upper part may also be formed and engage into one another such that at least one electrically insulating partition wall is formed. The partition wall may, for example, separate two adjacent individual coils from one another.

Each housing module may also comprise a side wall structure having multi-reinforcement elements, at least one of the multi-reinforcement elements being of a height that is equal to or half that of an outer wall of the housing module. This may improve the stability of the housing modules, because the lower face or the upper face are prevented from being pressed inwards, or a force applied to the outer walls can be more easily offset, for example. For example, only the lower part or only the upper part has said multi-reinforcement elements, which should thus be just as high as the outer wall of the housing module. In another embodiment, both the upper part and the lower part have said multi-reinforcement elements, which may thus be, for example, each approximately half as high as the outer wall and which meet, and are then overall just as high as the outer wall, when the upper part and the lower part are coupled to one another.

The multi-reinforcement elements may also incorporate an attachment recess in the housing module, it being possible for the attachment recess to be designed to receive a one-part or multi-part bush, which may be produced from a material other than that of the housing module, in particular from a hard metal. As a result, the housing module or the housing module set having the plurality of housing modules may advantageously be attached to a machine component.

At the same time, the multi-reinforcement elements may form a guide for a power line within the housing module. The multi-reinforcement elements may, for example, be offset from one another and thus form paths in which a power line can be fixedly laid.

According to another embodiment, a stabilization element produced separately from the housing modules is provided, it being possible for each housing module to comprise a holder that is designed to hold the stabilization element completely or in part. For example, the stabilization element is formed in the manner of a bar that engages into the holders of at least two housing modules. The housing modules may also be designed such that, when the modules are filled with the insulating filler, the stabilization element is also surrounded by the filler and the filler also hardens here. The stabilization element may therefore contribute to the rigidity of the housing module set.

Furthermore, in at least one of the housing modules, at least one of said attachment recesses may be present, it being possible for the at least one attachment recess to be designed to receive a one-part or multi-part bush.

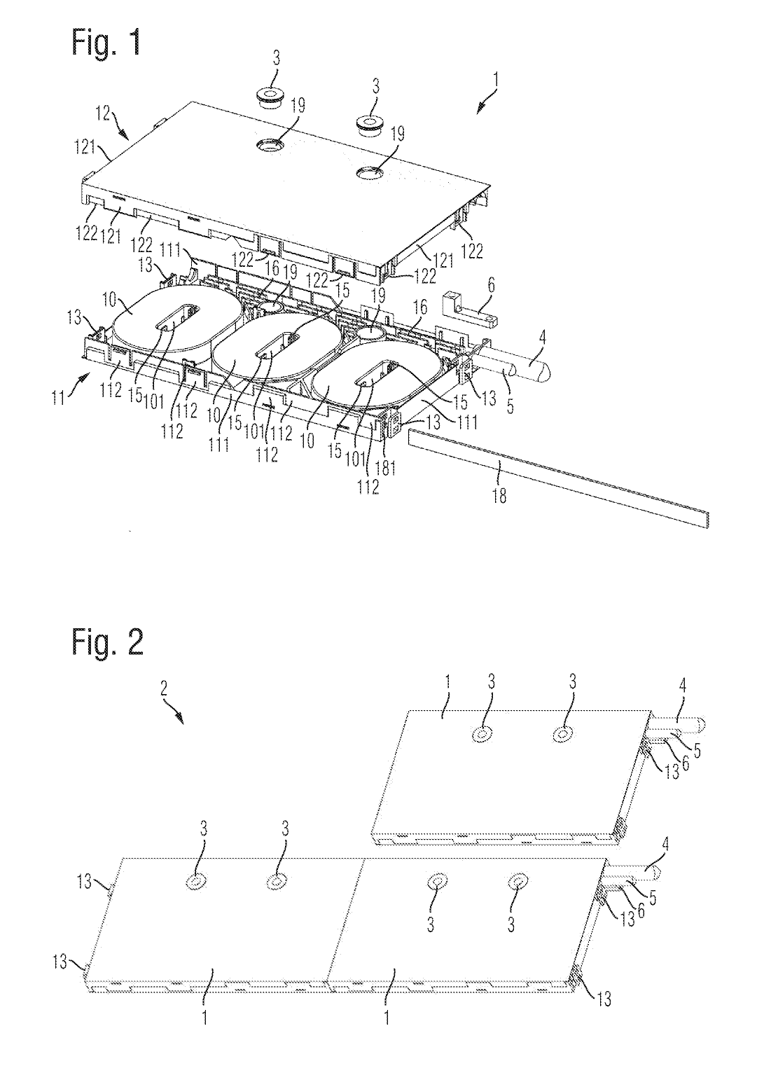

FIG. 1 is a schematic view, given by way of example, of a coil arrangement for an electric motor. The electric motor may be a linear motor, for example an ironless linear motor (also referred to as a coreless linear motor), for example a three-phase ironless linear motor.

The coil arrangement may comprise a number of individual coils 10. For example, at least one individual coil 10 is provided for each phase of the electric motor. For example, the individual coils 10 do not have a core, but instead have an inner hollow 101. The individual coils 10 may each be ironless individual coils, i.e. designed as air-core coils, for example. For example, each individual coil comprises a coil that has been wound from a wire provided with an insulation layer.

The individual coils 10 are arranged in a housing module 1. In other words, the housing module 1 is designed to enclose the individual coils 10. The housing module 1 may have been produced separately from the coil arrangement as a plastics part, for example as an injection-molded part.

The material of the housing module 1 may be selected depending on the mechanical and electrotechnical requirements for the housing module 1. High-performance materials or technical materials are possible, it being possible for the selected material to have an amorphous or semi-crystalline structure. For example, a material from the following group of materials may be provided for the housing module 1: polyphenylene sulfide (PPS), polybutylene terephthalate (PBT), acrylonitrile/butadiene/styrene copolymers (ABS), liquid-crystal polymers (LCP), polyetherimide (PEI), polyether ether ketone (PEEK).

The housing module 1 may comprise a lower part 11 and an upper part 12. The lower part 11 and the upper part 12 may be designed to be joined to one another with an interlocking fit in order to enclose the individual coils 10.

The housing module 1 may also be provided with one or more attachment recesses 19 that make it possible to attach the housing module 1 to a machine component. The attachment recesses 19 may each be continuous. For example, the attachment recesses 19 (for example, in the form of attachment bores) are designed to receive a one-part or multi-part bush 3 at least in part. For example, the upper part 12 and the lower part 11 may be bolted to one another by means of the bushes 3, which will be described in more detail. Furthermore, the housing module 1 may also be attached to a machine component by means of the bushes 3, as is described in more detail below.

The lower part 11 may comprise a first outer wall structure 111, and the upper part 12 may comprise a second outer wall structure 121. When the upper part 12 and lower part 11 are joined to one another, said outer wall structures 111 and 121 may mate and form the outer wall of the housing module 1. In an embodiment given by way of example, the height of the housing module 1, formed by the outer wall, is in the range of from 5 mm to 10 mm, for example, and the lower face of the housing module 1, formed by the lower part 11, has a length of from 50 mm to 150 mm and a width of from 25 mm to 80 mm, for example; the upper face of the housing module 1, formed by the upper part 12, may be of the same length and width as the lower face.

In order to assist with the mating between the upper part 12 and the lower part 11, the lower part 11 may comprise first connection elements 112, and the upper part 12 may comprise second connection elements 122. Said connection elements 112 and 122 may be provided not only in the outer wall structures 111/121, but also on the base of the lower part 11 and/or the base of the upper part 12, for example, as is shown in FIG. 1. When the two parts 11 and 12 are joined to one another, said connection elements 112 and 122 may engage into one another, for example in the manner of a latching or plug-in fastener.

FIG. 18 shows that the first outer wall structure 111 of the lower part 11 may have a structured end portion that comprises, for example, first bevels 113 that are offset from one another. Similarly, the second outer wall structure 121 of the upper part 12 may have a structured end portion that comprises, for example, second bevels 123 that are offset from one another. When the upper part 12 and the lower part 11 are joined to one another, the first bevels 113 and the second bevels 123 may be positioned so as to be complementary to one another, as is shown in the upper portion of FIG. 18. After the two parts 11 and 12 have been joined to one another, the surfaces of the first bevels 113 abut the surfaces of the second bevels 123 (see lower portion of FIG. 18). This makes it possible to prevent longitudinal offset between the upper part 12 and the lower part 11, which is indicated by the crossed-out arrow in FIG. 18.

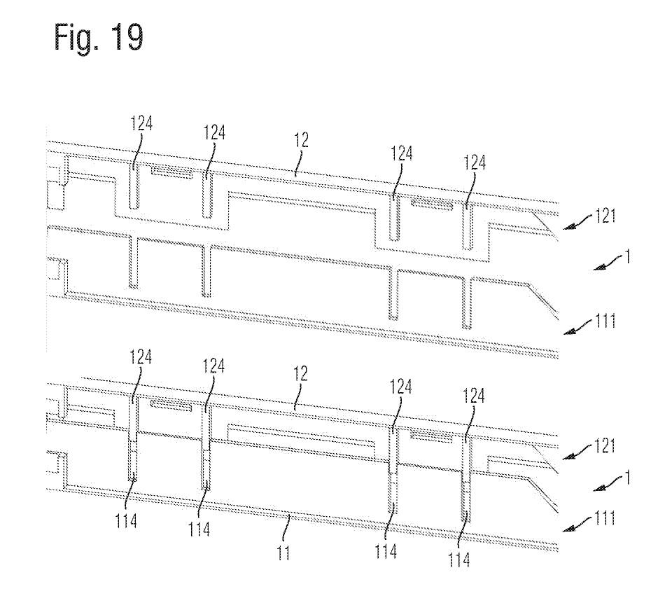

In order to further assist with the mating between the upper part 12 and the lower part 11, the lower part 11 may comprise first guide elements 114, and the upper part 12 may comprise second guide elements 124, as is shown in FIG. 19. The first guide elements 114 and the second guide elements 124 may comprise, for example, guide pins (see reference numerals 124) and guide grooves (see reference numerals 114), which are complementary to said guide pins and into which the guide pins can be engaged. For example, before the upper part 12 and the lower part 11 are joined to one another, they are aligned with one another (see upper portion of FIG. 19) and are then joined to one another such that the first guide elements 114 and the second guide elements 124 engage into one another, for example such that the guiding forces are engaged into the guide grooves (see lower portion of FIG. 19). FIG. 19 is only a detail of the housing module 1 and it is to be understood that, for example, in a region that is not shown, the upper part 12 has two guide elements 124 in the form of guide grooves, into which first guide elements 114 in the form of guide pins of the lower part 11 can be engaged.

The upper part 12 and the lower part 11 may be of the same kind, for example identical to one another. If one of the two parts 11 and 12 is rotated by 180°, they can still be joined to one another with an interlocking fit.

In one embodiment, the housing module 1 substantially consists of only the two base parts, i.e. the lower part 11 and the upper part 12, which are identical to one another.

With reference to FIG. 1 again, a side wall structure having multi-reinforcement elements 16 may be formed between the outer wall 111/121 and the individual coils 10, it being possible for at least one of the multi-reinforcement elements 16 to be of a height which is equal to that of the outer wall of the housing module 1. For example, only the lower part 11 or only the upper part 12 has said multi-reinforcement elements 16, which should thus be just as high as the outer wall of the housing module 1. In another embodiment (e.g. in which the upper part 12 and the lower part 11 are identical to one another), both the upper part and the lower part have said multi-reinforcement elements 16, which may thus be, for example, each approximately half as high as the outer wall and which meet, and are then overall just as high as the outer wall, when the upper part 12 and the lower part 11 are coupled to one another.

At the same time, the multi-reinforcement elements 16 may form a guide for a power line, for example for the continuation of a power lead 4 and/or the continuation of a signal lead 5.

Furthermore, the housing module 1 may be designed to receive an earth connection 6 at least in part, it being possible for the earth connection 6 to be designed in the manner of an earthing bar, for example.

Any remaining hollow space inside the housing module 1 after the individual coils 10 have been inserted may be filled with an insulating filler, for example a potting compound, such as a resin.

As has already been explained in the introductory part, the electric motor may be provided in various classes. For example, just a single individual coil 10 is provided for each phase for a class 1 electric motor, two individual coils 10 are provided for each phase for a class 2 electric motor, three individual coils 10 are provided for each phase for a class 3 electric motor, four individual coils 10 are provided for each phase for a class 4 electric motor, and so on. In order to form electric motors of a particular class, a corresponding number of housing modules 1 is provided, for example. For example, each housing module 1 is designed to enclose a number of individual coils 10 that corresponds to the number of phases of the electric motor. Therefore, if said motor is a three-phase electric motor, for example, each housing module 1 is designed to enclose three individual coils 10, as is shown in FIG. 1 by way of example. In one embodiment, the electric motor may therefore be a multi-phase electric motor, and the number of individual coils 10 corresponds to the number of phases multiplied by a whole-number factor, the number of the housing modules 1 being identical to the whole-number factor. For example, only one housing module 1 is therefore provided for an above-described class 1 electric motor, two housing modules 1 are provided for a class 2 electric motor, three housing modules 1 are provided for a class 3 electric motor, four housing modules 1 are provided for a class 4 electric motor, and so on. The factor can thus express a performance class of the electric motor.

So that a plurality of housing modules 1 can be coupled to one another, each housing module 1 may comprise at least one coupling element 13 which is designed to couple two of the housing modules 1 to one another. Furthermore, a stabilization element 18 produced separately from the housing modules 1 may be provided, each housing module having a holder 181 that is designed to hold the stabilization element 18 completely or in part. The stabilization element 18 may be designed in the manner of a bar and be of a length which corresponds approximately to a whole-number multiple of the length of a housing module 1.

The coupling elements 13 are, for example, provided on the outer wall structures 111/121 such that the housing modules 1 are coupled to one another not on the lower or upper face of the housing modules 1, but on the outer walls, as is shown in FIGS. 1 and 2.

The above-mentioned embodiments relating to the coupling of the housing modules 1 to one another are shown schematically and by way of example in FIG. 2. The plurality of housing modules 1 may form a housing module set 2.

For example, all the housing modules 1 have a sufficient number of identical dimensions such that said modules can be produced by means of an injection-molding process in the same cavity. This may make it more cost-effective to produce the housing module set 2.

All the housing modules 1 may have identical dimensions. In the embodiment according to FIG. 2, each housing module 1 encloses three individual coils 10, for example. The housing modules 1 are coupled to one another by means of the coupling elements 13, and the stabilization element 18 may contribute to the mechanical robustness and rigidity of the housing module set 2.

On account of this modular character of the housing module set 2, electric motors of various performance classes may be produced in a cost-effective manner.

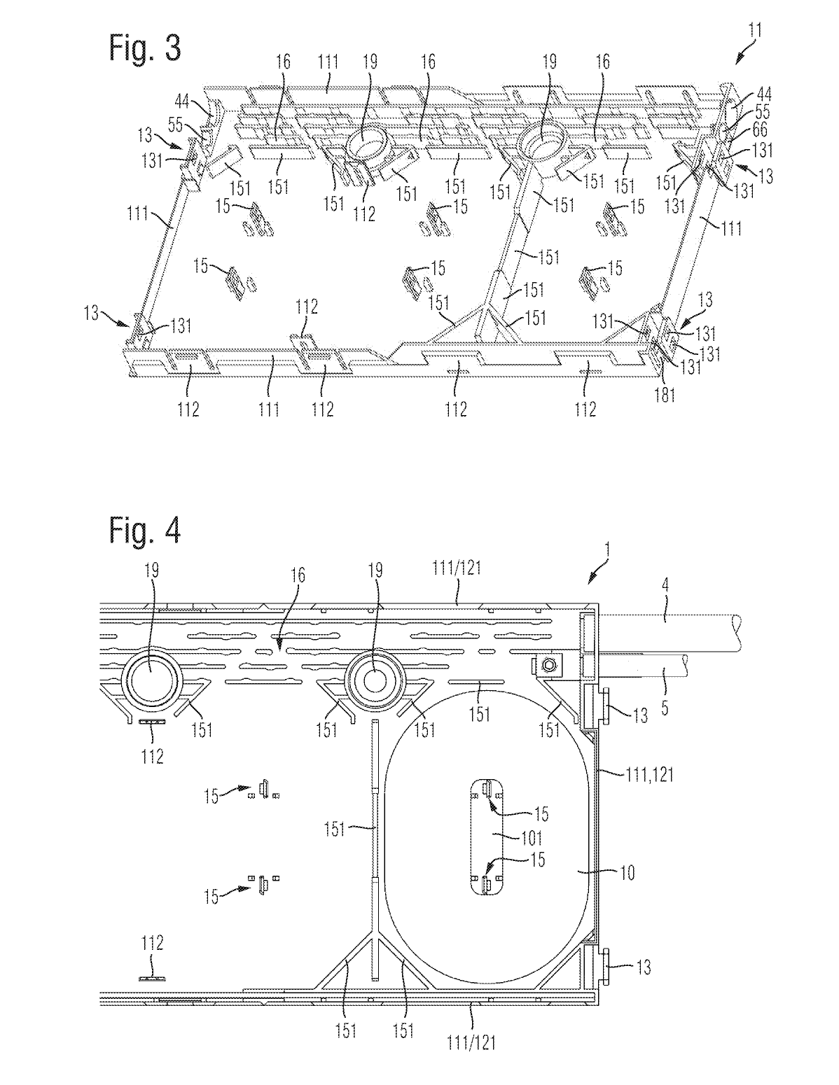

Looking at FIGS. 3 to 19, further optional features of the housing modules 1 are intended to be described. It goes without saying that the same reference numerals may refer to the same elements in the drawings and an explanation will not be given again for each element for every figure.

According to the embodiment in FIG. 3, which shows a detail of the lower part 11 of the housing module 1, the housing module 1 may comprise, for each of the individual coils 10, a positioning means 15 that allows the individual coil 10 in question to be inserted in a positionally precise manner. In the embodiment according to FIG. 3, two positioning means 15 are provided for each individual coil 10, which means are suited, in terms of the location thereof within the housing module 1, to the dimensions of said hollow 101, for example, and this is shown slightly more clearly in FIG. 4 for one individual coil 10.

In order to externally confine the individual coils 10, further positioning aids 151 may be provided, some of which may also be formed by the outer wall structure 111. The positioning aids 151 may also be in the form of insulating partition walls, as is shown in FIG. 1. Here, the left-hand individual coils 10 are separated from the right-hand individual coil 10 in the longitudinal direction. In other words, the lower part 11 and the upper part 12 may be designed and engage into one another such that at least one electrically insulating partition wall is formed.

Holders 44 for the power lead 4, holders 55 for the signal lead 5, a holder 66 for the earth connection 6 and the holder 181 for the stabilization element 18 may also be provided in the outer wall structure 111.

The coupling elements 13 may comprise a recess 131 that is designed to make it possible for an insulating filler (for example, a resin) to flow between the interiors of the two housing modules 1 that are coupled to one another by means of the coupling element 13. It is thus possible, for example, to start with only one of the housing modules 1 when the housing modules 1 of the housing module set 2 are filled, and on account of the recess 131, it can be ensured that all the housing modules 1 are filled with the filler. At the same time, the composite of the housing modules 1 is also reinforced at the locations of the coupling elements 13 when the filler hardens.

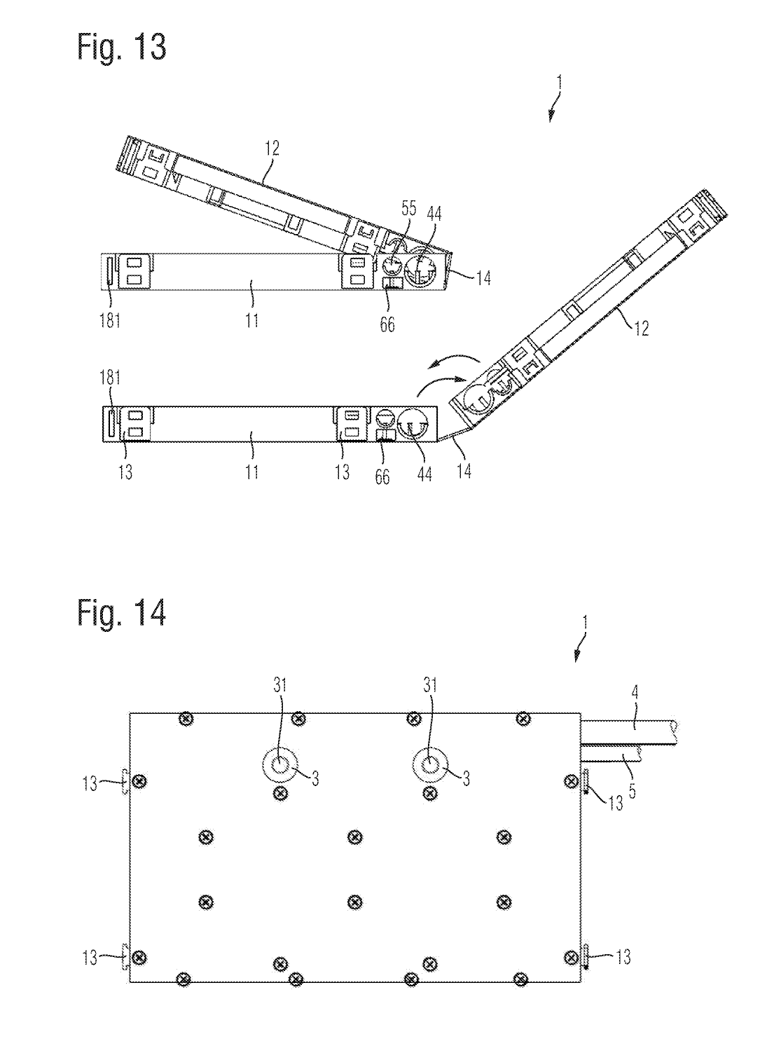

FIG. 5 shows how the lower part 11 and the upper part 12, which may be identical to one another, can be joined to one another, specifically in the direction indicated by the pair of opposing arrows. The identical parts 11 and 12 are offset from one another by 180° such that said parts can mate with an interlocking fit. In this embodiment, the two parts 11 and 12 are produced as individual parts. In another embodiment shown schematically and by way of example in FIGS. 12 and 13, the lower part 11 and the upper part 12 are produced as an integral plastics part and are interconnected by a flexible side wall 14. For example, the side wall 14 is designed such that it is possible to join the upper part 12 and the lower part 11 to one another in the direction indicated by the pair of opposing arrows, i.e. by “folding shut”. However, in this embodiment too, the lower part 11 and the upper part 12 may again be identical to one another; the components of the two parts 11 and 12 are merely provided symmetrically to one another along a longitudinal axis.

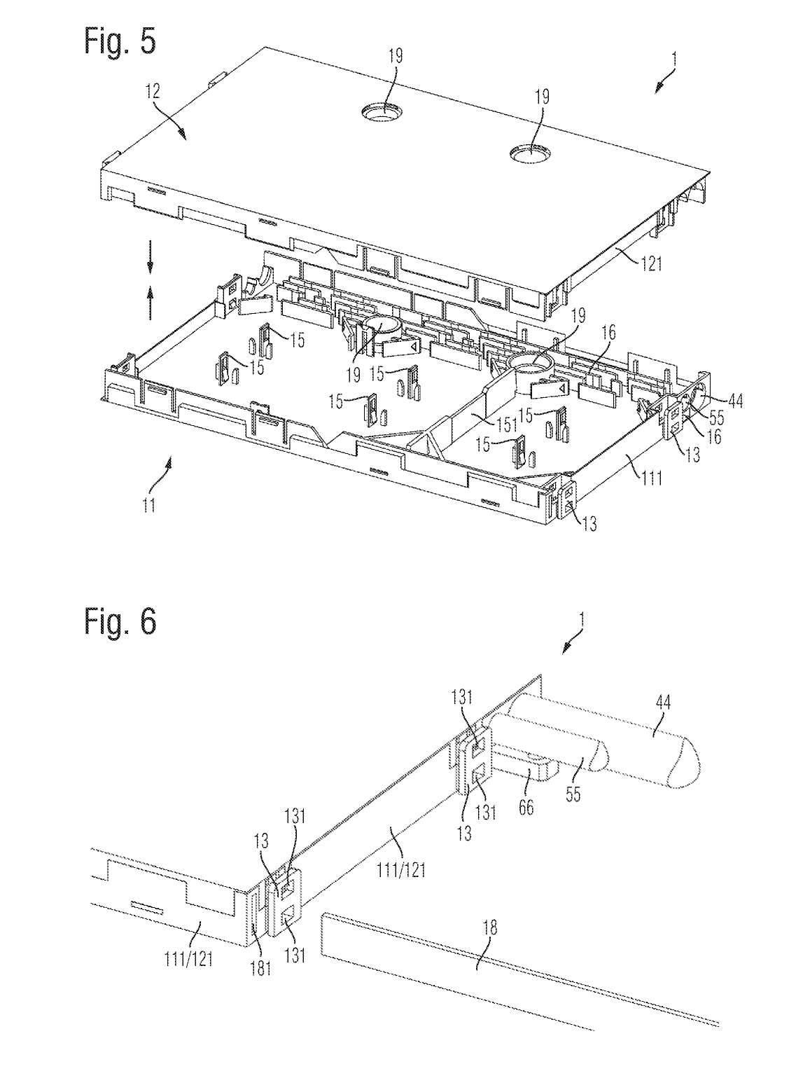

FIG. 6 shows slightly more clearly that the housing module 1 may be designed to hold the stabilization element 18 by means of the holder 181. Said stabilization element 18 projects into at least two of the housing modules 1 and may have a longitudinal extension which approximately corresponds to the entire longitudinal extension of the plurality of housing modules 1 that are interconnected by means of the stabilization element 18. At the same time, this may approximately correspond to the length of the electric motor. When the housing modules 1 are filled with the insulating filler, the stabilization element 18 may also be covered such that, in particular after the filler has hardened, increased rigidity of the housing module set 2 can be achieved by means of the stabilization element 18.

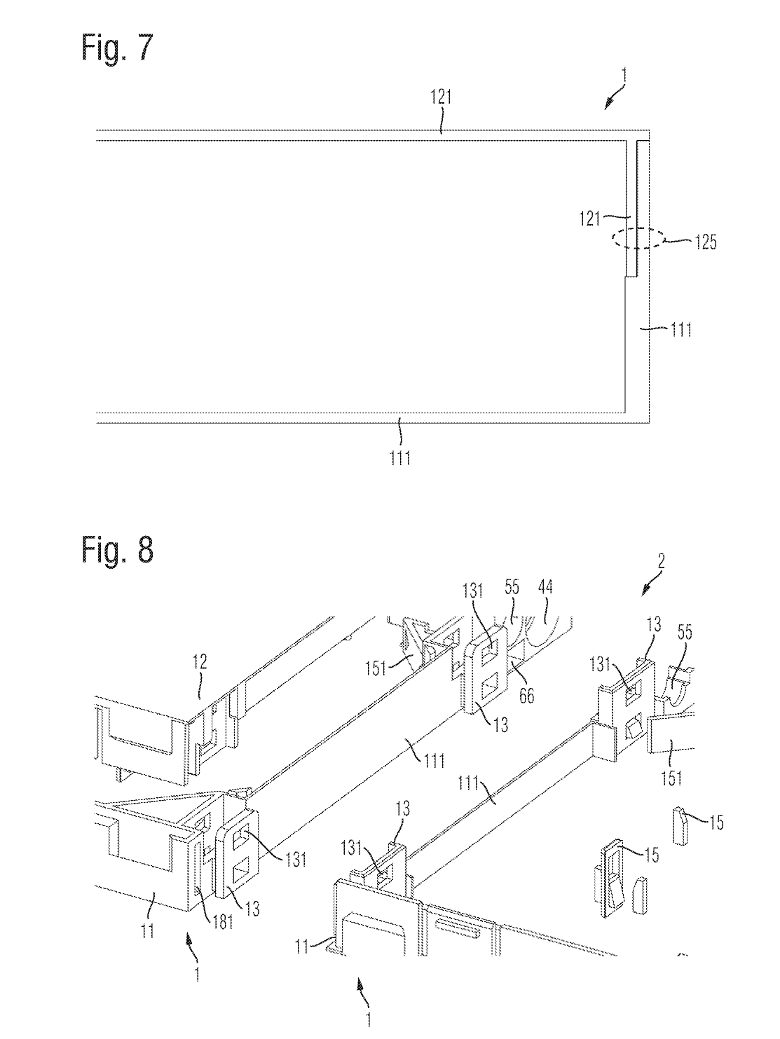

Looking at the embodiment from FIG. 7, it is intended to be understood that, after the two parts 11 and 12 have been joined to one another, the first outer wall structure 111 of the lower part 11 and the second outer wall structure 121 of the upper part 12 may engage into one another such that said lower and upper parts form a double-wall structure 125 of the housing module 1 at least in part. In other embodiments of the housing module 1, said double-wall structure 125 may be formed in the outer wall entirely or at least mostly and, in other embodiments, only by a small proportion, as is shown in FIG. 7. For example, the double-wall structure 125 has a thickness in the range of from 0.3 mm to 2 mm, it being possible for the thickness to be defined on the basis of the insulation requirements and the material of the housing module 1. A double-wall structure 125 of this kind may also advantageously allow relevant technical standards to be fulfilled, for example the electrical insulation that is to be ensured, such as the “creepage distance” aspect. For example, the creepage distance between at least one of the individual coils 10 (which may carry a high potential) and the surroundings (i.e. the region outside the housing module 1) can be increased on account of the double-wall structure 125.

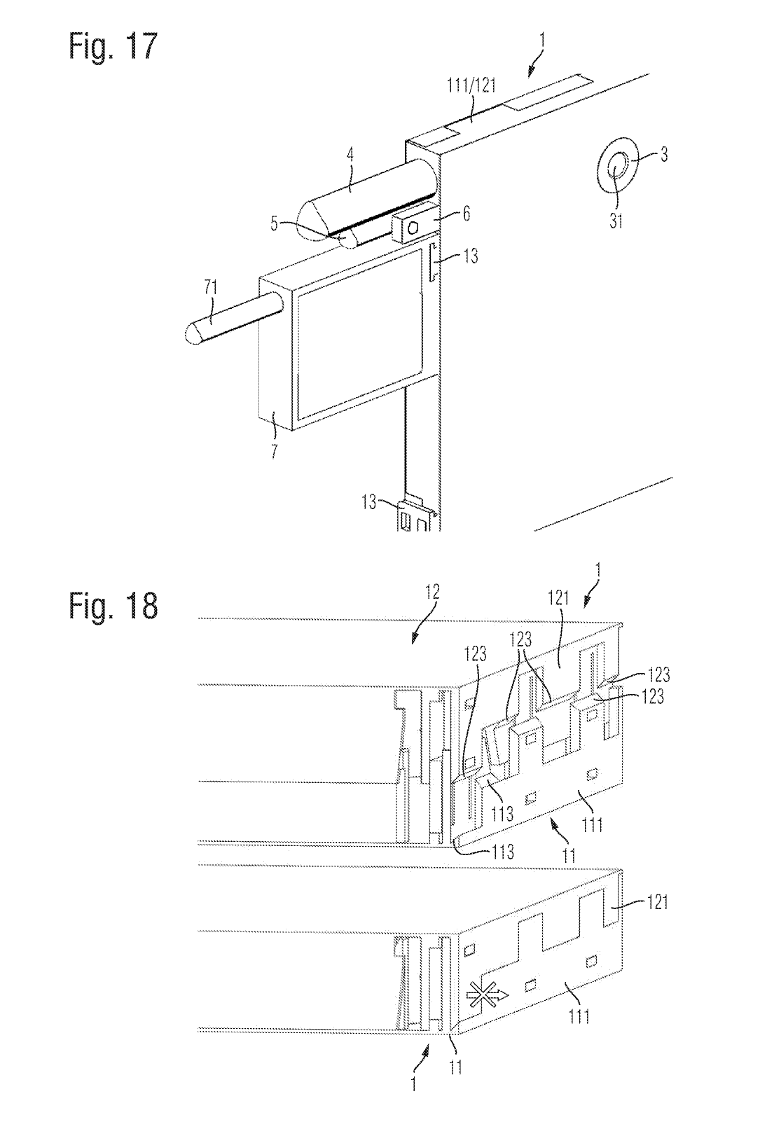

FIG. 8 is a schematic view, given by way of example, of a detail of two housing modules 1 to be coupled to one another. The coupling elements 13 of the housing modules 1 may be complementary to one another by said elements engaging into one another in the manner of a latching fastener, for example, such that the outer walls 111/121 of the housing modules 1 that are coupled to one another touch one another. For example, half of the number of coupling elements 13 of one housing module 1 may project from the outer walls 111/121 (see left-hand housing module 1), whereas the other half is formed by a type of recessed structure (see right-hand housing module 1). It goes without saying that, after the housing modules 1 have been joined to one another to form the housing module set 2, “non-used” coupling elements 13 of at least one housing module 1 may protrude in the process. According to one embodiment shown schematically and by way of example in FIG. 17, the coupling elements 13 may be designed to receive a device external to the housing module, for example a sensor 7. The sensor 7 may be a Hall effect sensor, for example. For example, the sensor 7 comprises a sensor signal line 71 via which the sensor 7 outputs sensor measurement signals and/or receives sensor control signals.

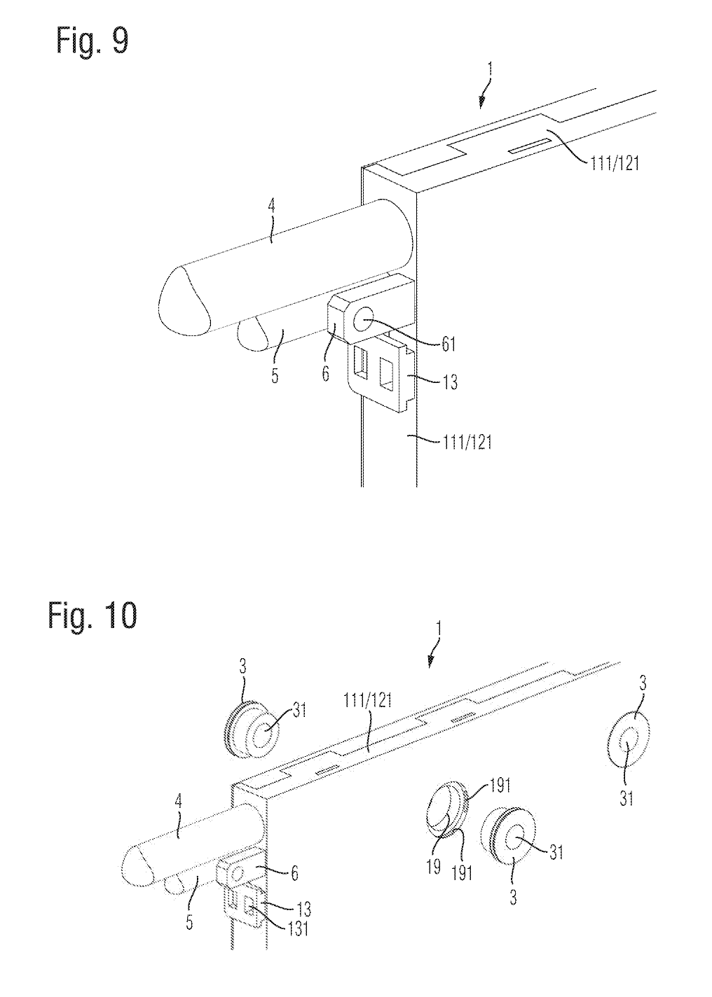

According to one embodiment, the holder 44 for holding the power lead 4 and the at least one coupling element 13 are adjacent to one another, as is shown in FIG. 9. The earth connection 6 may also protrude from the housing module 1, which connection may comprise a recess 61 that is used, for example, to couple an earthing cable.

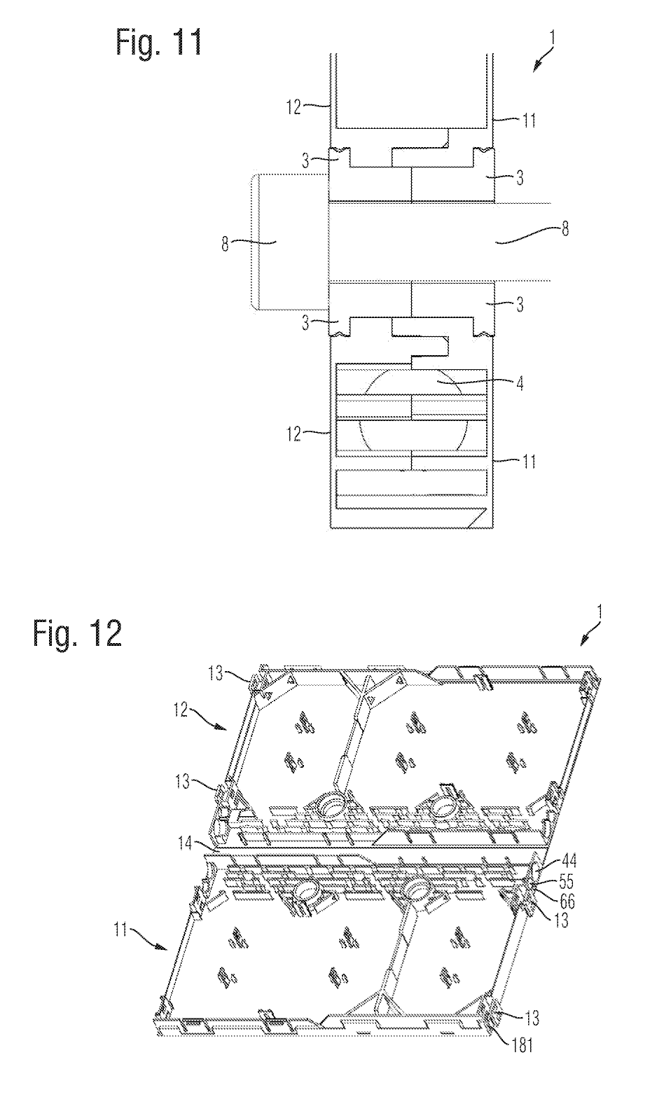

With reference to the embodiment according to FIG. 10, slightly more detail is intended to be provided on the attachment recesses 19 of the housing module 1 that were already described at the outset. As mentioned, said attachment recesses may be used to ultimately attach the housing module 1 to a machine component. For this purpose, the attachment recesses 19 may each be designed to receive a one-part or multi-part bush 3. To that end, the attachment recesses 19 may each comprise a threaded structure 191. The housing module 1 may comprise a plurality of said attachment recesses 19, for example at least two. Each of the attachment recesses 19 may also be designed (by means of the threaded structure 191) to receive bushes 3 from both sides. The threaded structure 191 may be formed, for example, by a number of grooves and mating grooves. Furthermore, the attachment recesses 19 may be supported by the multi-reinforcement elements 16, which may additionally contribute to an increase in stability of the housing module 1. The lower part 11 and the upper part 12 may also be bolted together by means of the bushes 3, as has already been mentioned in the introductory part and as is shown in FIG. 11.

In one embodiment, the bushes 3 have a continuous recess 31. In said recess, a coupling member 8, for example in the form of a bolt, may bring about the coupling between the housing module 1 and the machine component, as is shown in FIG. 11 by way of example. By the housing module 1 being bolted to the machine component, for example a force that negatively affects the housing module 1 is not exerted, but rather only a force that acts on the bushes 3 that engage in the attachment recess 19 and hold the upper part 12 and the lower part 11 together. Therefore, if a bolt 8 is placed through the bushes 3, the housing module 1 can be attached to the machine component by means of said bolt 8, without the housing module 1, which may be produced from a plastics material, being squashed in the process. The force of the bolt 8 pushes the two bushes 3 together and also fixes the two housing halves, i.e. the lower part 11 and the upper part 12, to one another in the process (although said parts are already held together by means of the aforementioned latching connections), and in particular fixes the housing module 1 to the machine component.

Indeed, on account of a structure of this kind, larger forces can act on the attachment recesses 19 and thus on the housing module 1. It may therefore be expedient for the attachment recesses 19 to be each reinforced by said one-part or multi-part bushes 3, which may be produced, for example, from a hard material, such as metal.

In FIG. 14, points at which the upper part 12 engages with the lower part 11 by means of said connection elements 112 and 122 are marked with crosses. This illustration shows that, in some embodiments, the positioning means 15 and/or the coupling elements 13 may also form connection elements 112/122 of this kind. According to one embodiment, the positioning means 15 and/or the coupling elements 13 are therefore designed to form a latching connection between the lower part 11 and the upper part 12.

At this juncture, attention is drawn to a particular property of the coupling elements 13 according to one or more embodiments: each coupling element 13 may a) be designed to both (i) couple two housing modules 1 to one another and (ii) form a latching connection between the upper face 12 and the lower face 11 of the housing module 1 and b) comprise said recess 131, which makes it possible for the insulating filler to flow between the interiors of the two housing modules 1 that are coupled to another by means of the coupling element 13 when the interior of the housing module 1 is filled with the insulating filler.

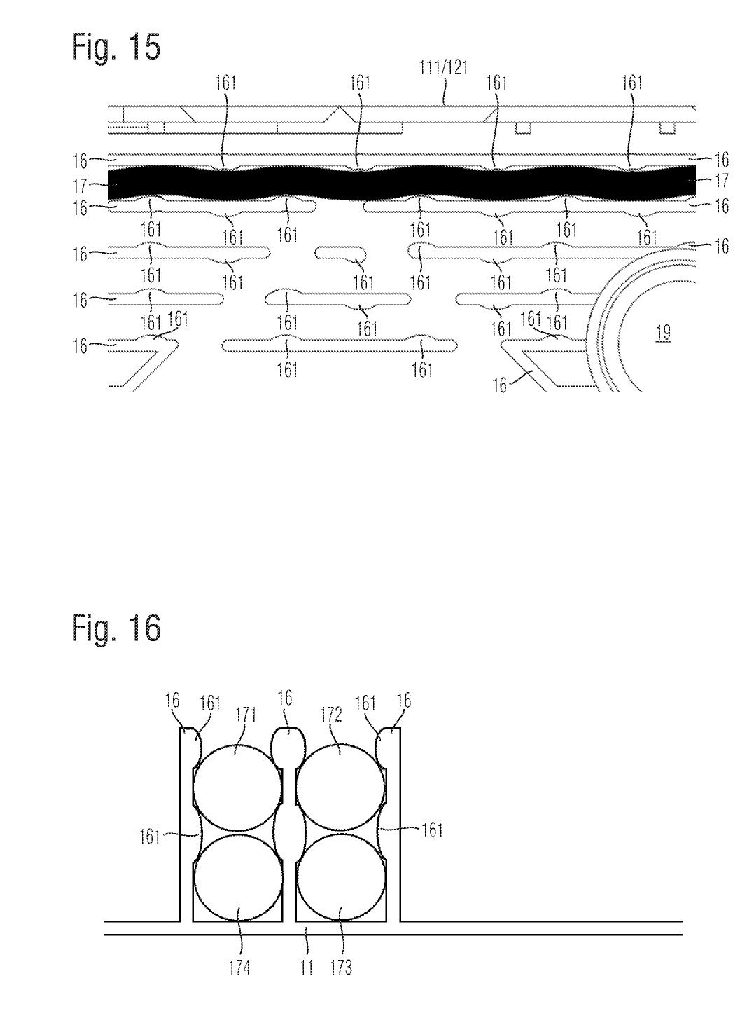

A number of features of the multi-reinforcement elements 16, given by way of example, are shown in FIG. 15. For example, the multi-reinforcement elements 16 may comprise a plurality of wall elements which are offset from one another in the longitudinal and transverse directions and which may each be of the same height as the outer wall 111/121, as has already been indicated above. Said wall elements may also be parallel to the outer wall 111/121 of the housing module 1. By being offset from one another, the multi-reinforcement elements 16, for example in the form of said wall elements, may have a guide for a power line 17, the power line 17 being connected, for example, to at least one of the power lead 4 and the signal lead 5. In FIG. 15, only one power line 17 is shown; however, it goes without saying that lines may also be laid in the adjacent guides that are formed by the plurality of the multi-reinforcement elements 16.

According to one embodiment, the multi-reinforcement elements 16 are designed to form substantially the entire guide system required to guide power and/or signal lines within the housing module 1.

In order to form the guides, it may be expedient for the multi-reinforcement elements 16 to have locally widened portions 161 which may cause the formed guide to locally taper accordingly, as is shown in FIG. 15. In this way, the attachment of the power line 17 within the housing module 1 can be supported. For example, on account of a particular locally widened portion 161, the power line 17 is pressed against the wall element opposite the locally widened portion 161. This may prevent the power line 17 from slipping out of place.

At this juncture, it is noted that, when the interior of the housing module is filled with the insulating filler, the power lines 17 laid in the guides formed by the multi-reinforcement elements 16 may also be surrounded by the filler.

Looking at the embodiment according to FIG. 16, the multi-reinforcement elements 16 may also each have a plurality of locally widened portions 161 that are offset from one another along the height of the multi-reinforcement element in question, for example. In this way, guides located one above the other may be formed for a plurality of lines 171, 174 or 172, 173.

One or more of the above-described embodiments relate to a housing module set for a coil arrangement of an ironless linear motor, the housing module set comprising a plurality of housing modules that may each substantially consist of two identical parts, specifically the aforementioned upper part and the aforementioned lower part. The upper part and the lower part may be produced as an injection-molded part in a cost-effective manner, either separately or as an integral part. The housing modules being inexpensive to produce make it advantageously possible to form ironless linear motors of various performance classes. The housing modules are distinguished by a robust mechanical structure that can be obtained entirely by means of an injection-molding method.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A coil arrangement for an electric motor, the coil arrangement comprising:
a plurality of individual coils; and
a plurality of housing modules, each of the housing modules being a plastics part separately produced from the coil arrangement, and each of the housing modules being designed to enclose the same amount of the individual coils.

2. The coil arrangement according to claim 1, wherein the electric motor is a multi-phase electric motor, wherein a total number of the individual coils provided in the coil arrangement corresponds to a number of phases multiplied by a whole-number factor, and wherein a total number of the housing modules is identical to the whole-number factor.

3. The coil arrangement according to claim 1, wherein all of the housing modules share a sufficient number of identical dimensions such that the housing modules are producible by an injection-molding process in the same cavity.

4. The coil arrangement according to claim 1, wherein all of the housing modules each comprise at least one coupling element which is designed to couple two of the housing modules to one another.

5. The coil arrangement according to claim 4, wherein the at least one coupling element comprises a recess that is designed to allow for an insulating filler to flow between interiors of the two housing modules that are coupled to one another via the at least one coupling element.

6. The coil arrangement according to claim 4, wherein the at least one coupling element forms a latching fastener at least in part.

7. The coil arrangement according to claim 1, wherein each of the housing modules comprises a lower part and an upper part, which in each case cover and enclose the same amount of the individual coils.

8. The coil arrangement according to claim 7, wherein the lower part and the upper part are produced as an integral plastics part and are interconnected by a flexible side wall.

9. The coil arrangement according to claim 7, wherein the lower part and the upper part have a same design.

10. The coil arrangement according to claim 7, wherein at least one of the lower part and the upper part comprises a positioner which allows the respective individual coils to be inserted in a positionally precise manner.

11. The coil arrangement according to claim 7, wherein the lower part and the upper part are formed and engage into one another in such a manner that at least one electrically insulating partition wall is formed.

12. The coil arrangement according to claim 1, wherein each of the housing modules comprises a side wall structure having multi-reinforcement elements, wherein at least one of the multi-reinforcement elements is of a height that is equal to or half that of an outer wall of the respective housing module.

13. The coil arrangement according to claim 12, wherein the multi-reinforcement elements form a guide for a power line.

14. The coil arrangement according to claim 1, further comprising a stabilization element produced separately from the housing modules, wherein each of the housing modules has a holder that is designed to hold the stabilization element completely or in part.

15. The coil arrangement according to claim 1, wherein the electric motor is an ironless linear motor.

16. The coil arrangement according to claim 1, further comprising at least one attachment recess in at least one of the housing modules, wherein the at least one attachment recess is designed to receive a one-part or multi-part bush.

17. A housing module set for a coil arrangement for an electric motor, the housing module set comprising:
a plurality of housing modules, each of the housing modules being an injection-molded part separately produced from the coil arrangement, and each of the housing modules being designed to enclose the same amount of individual coils of the coil arrangement.

18. A method of producing a coil arrangement for an electric motor, the method comprising:
injection molding a plurality of housing modules from a plastics material; and
inserting a same amount of individual coils of the coil arrangement in each of the housing modules.
